(19) United States
(12) Patent Application Publication
(10) Pub. No.: US 2010/0244447 A1
(43) Pub. Date: Sep. 30, 2010

(54) Continuously Variable Transmission Ratio Device with Optimized Primary Path Power Flow

(75) Inventors: Swaminathan Gopalswamy, Novi, MI (US); Ravindra Dixit, Ann Arbor, MI (US); John Jad Batteh, Ann Arbor, MI (US)

Correspondence Address: MILLER, CANFIELD, PADDOCK AND STONE, 277 SOUTH ROSE STREET, SUITE 5000, KALAMAZOO, MI, 49007, US

(73) Assignee: Emmeskay, Inc., Plymouth, MI (US)

(21) Appl. No.: 12/732,720

(22) Filed: Mar. 26, 2010

Related U.S. Application Data
(60) Provisional application No. 61/164,685, filed on Mar. 30, 2009.

(51) Int. Cl. F03D 9/02; F03D 9/00; H02K 17/18; F16H 3/76

(52) U.S. Cl. 290/50; 290/55; 310/125; 475/269; 475/31

(57) ABSTRACT

A continuously variable transmission ratio device with optimized system efficiency by maximizing power flows through the primary power flow paths. The device is constructed from more than one fixed gear ratio device and controlled via a variator that is connected between the fixed gear ratio devices. The construction and operation of the continuously variable transmission ratio device is such that it provides a wide range of speed ratios between connected input and output devices and optimized system efficiency subject to constraints on the power flow through the variator. This continuously variable transmission ratio device can be used effectively in energy generation applications where optimized system efficiency entails coupling input and output devices with varying speed ratios for optimal component efficiency.

### CROSS REFERENCE TO RELATED APPLICATION

This application asserts priority from U.S. provisional application 61/164,685, which was filed Mar. 30, 2009.

### BACKGROUND

The present disclosure is in the technical field of efficient harnessing of wind power. More particularly, the present disclosure is in the technical field of continuously variable transmission ratio mechanical gearing devices for wind turbines.

### Harnessing Wind Power

FIG. 1 shows a schematic of a wind turbine connected to a generator through a mechanical power transmission device. The wind turbine harnesses the wind power by using the wind speed to rotate the wind turbine. The generator harnesses the mechanical power from the rotation of the generator shaft into electrical power. The mechanical power transmission device accepts mechanical power from the wind turbine at a lower speed and delivers mechanical power to the generator shaft at a higher speed. The device's speed-ratio will be defined as the ratio of the speed of the output shaft (generator shaft) to the speed of the input shaft (wind turbine).

For any given wind speed, there is a certain optimum speed when maximum power can be extracted. Similarly, an optimum speed of rotation of the generator shaft is based on the generator design as well as the electricity grid to which the generator delivers electric power. This speed is usually a constant. The optimum speed-ratio will be the speed-ratio corresponding to the optimum speed of the wind turbine and generator speed.

In a typical wind energy application, the speed of the wind varies over a range of possible values. Correspondingly, the optimum speed-ratio varies over a range of possible values. If the mechanical transmission device is not capable of providing for a range of speed-ratios, it will result in a sub-optimal system where less power is harvested than is possible.

This disclosure is about a mechanical geared device that can provide for an adequate range of speed ratios.

### Fixed Speed Ratio Gear Drive (FR)

A fixed speed ratio gear drive is a mechanical power transmission device that allows for a fixed speed-ratio between the input and output shaft. There are many possible ways to realize such a device physically. For the purposes of illustration in this disclosure, they will be represented as shown in FIG. 2.

### Variators

FIG. 3 shows a representation of a variator. Variators transmit mechanical power while allowing for variable speed-ratios. There are many physical realizations of a Variator. Some examples are
(i) A mechanical Belt Transmission with variable sheaves
(ii) A mechanical Toroidal Transmission
(iii) A hydraulic or pneumatic pump/motor combination
(iv) An Electric Motor/Generator Combination.

### Power Split Gear Drive (PS)

FIG. 4 shows the schematic representation of the Power Split device. A Power Split Gear Drive is a mechanical power transmission device that allows for two power paths. In this description only, Power Split devices have three free shafts where power can be supplied (or extracted). These Power Split drives become significant components of larger systems as will be explained further below. There are many physical realizations possible for such a device.

### Continuously Variable Transmission (CVT)

A CVT is a mechanical power transmission device that allows for a range of speed-ratios between the input and output shafts. Such a variable transmission is achieved through a combination of fixed speed-ratio devices, Variators, and/or Power Split Devices.

FIG. 5-FIG. 7 show schematics of a few possible combinations of fixed speed drive mechanisms and Variators that can yield CVTs.

### PRIOR ART

The need for achieving variable turbine speed operation has been long recognized in the industry. The primary difficulty has been in finding a realization of this goal. There have been two directions in which work towards this goal has been pursued:
(i) Development of electrical solutions that will allow converting rotary power into electrical power at high efficiency over a range of generator speeds.
(ii) Development of CVT solutions that will allow mechanical power transmission from the wind turbine to the generator shaft at varying speed-ratios.

This disclosure is related to the second development above. Along the above lines of development, there has been prior work, some of which are listed:

1. U.S. Pat. No. 7,115,066 Title: Continuously variable ratio transmission

Abstract:
A continuously variable ratio transmission including a planetary gear set having a sun gear, a ring gear, and a planet carrier having at least two planet gears carried thereon, a control element including a servogenerator capable of generating electric power, and at least one auxiliary field coil adapted to be operatively connected to an output means to influence a power output level and AC power frequency of the output means, the at least one auxiliary field coil being powered by the servogenerator and constituting a load to the servogenerator, the speed of the servogenerator being capable of being controlled by the load; and a means for controlling an electrical current to the at least one auxiliary field coil form the servogenerator; where the servogenerator is capable of being driven to produce electrical power by a rotation of one of the sun gear, the ring gear, and the planet carrier.

2. U.S. Pat. No. 5,083,039 Title: Variable speed wind turbine

Abstract:
A variable speed wind turbine is disclosed comprising a turbine rotor that drives an AC induction generator, a power converter that converts the generator output to fixed-frequency AC power, a generator controller, and an inverter controller. The generator controller uses field orientation to regulate either stator currents or voltages to control the torque reacted by the generator. The inverter controller regulates the output currents to supply multi-phase AC power having leading or lagging currents at an angle specified by a power factor control signal.

3. U.S. Pat. No. 6,872,049 Title: Wind turbine comprising a planetary gear

Abstract
A wind turbine with a rotor, a nacelle and a tower. The nacelle comprises a planetary gear (4) with a planetary holder (5), on which the hub (6) of the rotor is rigidly secured, and which can be connected to the shaft of an electric generator. The planetary gear (4) comprises a ring gear (7) fixedly mounted on an engine frame (9) in the nacelle or on the member (8) rigidly connected to said frame. The planetary wheels (17a, 17b) of the planetary gear can run around a centrally arranged sun wheel (14) while engaging the latter. The sun wheel is optionally connected to a parallel gear (30). The planetary holder (5) is rotatably mounted in the ring gear (7) by means of at least two sets (17) of planetary twin wheels (17a, 17b). Each set of planetary twin wheels is mounted on a bogie shaft (19) on the planetary holder. Through an axially rearward collar (23) projecting beyond the ring gear, the planetary holder (5) is also rotatably arranged on the curved outer side (7b) of the of the ring gear (7) by means of an outer radial-axial-roller bearing (27). As a result, a wind turbine is obtained which is suited for generating very strong power and which is very compact and ensures a very advantageous transfer of the power at each planetary wheel.

4. U.S. Pat. No. 7,259,472 Title: Wind turbine generator

Abstract
A wind turbine generator including a nacelle having reduced size and weight is provided. The wind turbine generator includes a nacelle disposed on a tower. The nacelle includes a main shaft that is connected to a rotor head equipped with blades and that integrally rotates with the rotor head, a gearbox that increases the rotational speed of the main shaft and that outputs the resulting rotational speed, and a generator driven by the output from the gearbox. In the wind turbine generator, a drivetrain extending from the main shaft to the generator via the gearbox is disposed in the rotor head.

5. U.S. Pat. No. 7,008,348 Title: Gearbox for wind turbine

Abstract
A wind turbine gear box having a compound planetary gear arrangement having bearings providing improved reliability and with greater accessibility for servicing. The gear box has planet pinions and planet gears being rotated by a planet carrier around a sun gear which drives a final reduction stage, the final reduction stage and the adjacent end of the planet carrier being removable from the gear box housing to allow easy removal of the planet pinions and their associated bearings.

6. U.S. Pat. No. 6,607,464 Title: Transmission, especially for wind power installations

Abstract:
A transmission, especially for wind power installations includes a planetary stage on the input side that is mounted upstream of at least one gear stage. The planetary stage includes at least two power-splitting planetary gears that are mounted in parallel. A differential gear that is mounted downstream of the power-splitting planetary gears compensates for an unequal load distribution between the individual planetary gears caused by their parallel disposition.

### SHORTCOMINGS OF PRIOR ART

The majority of the work can be classified by the schematics shown in FIG. 5-FIG. 7.

A key aspect of these devices is the overall efficiency of the transmission, and the power going through the Variator. The overall efficiency of the transmission is clearly important because of its impact on the ability to harness wind power. The power going through the Variator is important because of two reasons:
(i) The cost of the Variator is generally proportional to the maximum power flow through the Variator. For example, if the Variator is an electric motor/generator type, then the associated power electronics would be very dependent on the maximum power flow that needs to be handled.
(ii) The Variator is in general the lower efficiency device, and hence if the power flow through Variator can be minimized, the overall losses can be minimized, and therefore the overall transmission efficiency can be improved.

In the devices in the Prior Art, the mechanizations all exhibit a linear relationship between the power through the Variator and the overall transmission ratio of the CVT. This behavior in turn imposes a severe compromise on the range of speed-ratios that can be achieved at a given cost.

The device described in this disclosure has been designed specifically to address this limitation in the Prior Art.

Some Notes on Prior Art:
1. Arrangement of planetary gears is different. The gearboxes are configured for a variety of purposes (reduction with compactness, load distribution, power distribution to multiple generators). None of the prior art uses the planetary power split transmission to achieve a higher speed ratio and increase aerodynamic efficiency. Single planetary gearbox similar to presently disclosed implementation has been outlined in (1). However as mentioned, the configuration is different. It uses a single planetary gearbox.
2. Power flow from one planetary to the other via an AC-AC converter for wind energy application is unique to presently disclosed mechanization.
3. Prior art does not mention the objective of increasing the speed band.
4. The use of motors/generators to control the power flow in a wind power context is not mentioned.
5. The use of controls to restrict output generator to a fixed speed while allowing rotor to maintain optimal tip speed ratio (TSR) is not covered.
6. In summary: certain aspects of presently disclosed system (planetary gearboxes etc) are disclosed, but no disclosure includes the solution similar to presently disclosed implementation (such as arrangement of planetary gears, control via motors, speed band, optimal TSR).

### BRIEF SUMMARY

The present disclosure is for a Continuously Variable Transmission device consisting of two power split devices connected by a variator that (i) provides a wide range of speed-ratios between the Input and Output Shaft and (ii) minimizes power losses from the Input to the Output shaft. Several physical realizations of this device are possible, and some of them are described in this disclosure with features including:
1. Use of two Power Split devices with a controlled flow of power between them through a Variator to allow variable transmission ratios.
2. Control means to obtain optimal efficiency though primary power path.
3. Use of an Energy Storage device to absorb energy pulsations into the system through events such as wind gust.
4. Use of hydraulic pump/motor as a means to achieve variable speed transmission for turbines.
5. Use of hydraulic/pneumatic accumulator for energy storage in wind turbine systems.
6. Use of a pair of motor/generator units in the secondary path to realize variable speed functionality.
7. Use of a battery pack system in a novel way to store excess energy from wind power systems.
8. Use of a power split device (i.e. sharing power flow through two paths) to statistically reduce the amount of load variability to which the gears are subjected.

For energy generation applications where optimized system efficiency entails coupling input devices, such as a wind turbine having an input shaft, and output devices, such as a generator with a shaft, with varying speed ratios of input and output shafts for optimal component efficiency, a continuously variable transmission ratio device may comprise:

a planetary power split transmission device including a first fixed gear ratio device and a second fixed gear ratio device; and

a variator allowing variable speed ratios connected between the first fixed gear ratio device and the second fixed gear ratio device for controlling the fixed gear ratio devices that optimize efficiency by maximizing power flow through primary power flow paths and allowing a wide range of speed ratios between connected input and output shafts. The variator can be hydraulic devices connected to each other by plumbing or valves, an electromagnetic device or equivalents.

### BRIEF DESCRIPTION OF THE DRAWINGS

The above mentioned and other features of this disclosure and the manner of obtaining them will become more apparent, and the disclosure itself will be best understood by reference to the following description of processes taken in conjunction with the accompanying figures, which are given as non-limiting examples only, in which:

FIG. 1 is a schematic of a wind turbine connected to a generator through a mechanical power transmission device;

FIG. 2 shows a fixed speed ratio gear drive;

FIG. 3 shows a representation of a variator;

FIG. 4 shows the schematic representation of the Power Split device;

FIG. 5 show schematics of a combination of fixed speed drive mechanisms and Variators with a direct drive and no power split CVT;

FIG. 6 shows schematics of a combination of fixed speed drive mechanisms and Variators with an input split, power split CVT;

FIG. 7 shows schematics of a combination of fixed speed drive mechanisms and Variators with an output coupled, power split CVT;

FIG. 8 is a schematic view of a variable transmission ratio device;

FIG. 9 is a schematic view of a variable transmission ratio device from FIG. 8 connected to a turbine and generator in an energy generation application;

FIG. 10 is a schematic view of the arrangement from which other arrangements can be obtained by selectively removing fixed ratio devices;

FIG. 11 is a schematic view of the arrangement showing operation controlled by a computer or microprocessor;

FIG. 12 is a schematic view of a realization of the device from FIG. 8 using planetary gear sets and a variator;

FIG. 13 is a realization of the device from FIG. 12 using hydraulic pump/motors;

FIG. 14 is an electrical realization of the device from FIG. 12;

FIG. 15 is an extension of the realization of the device from FIG. 13 incorporating hydraulic/pneumatic storage; and

FIG. 16 is an extension of the realization of the device from FIG. 14 incorporating electrical storage.

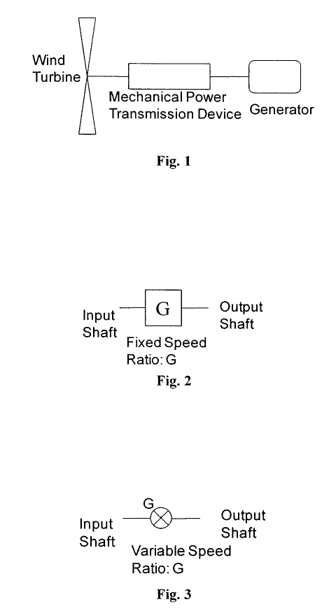

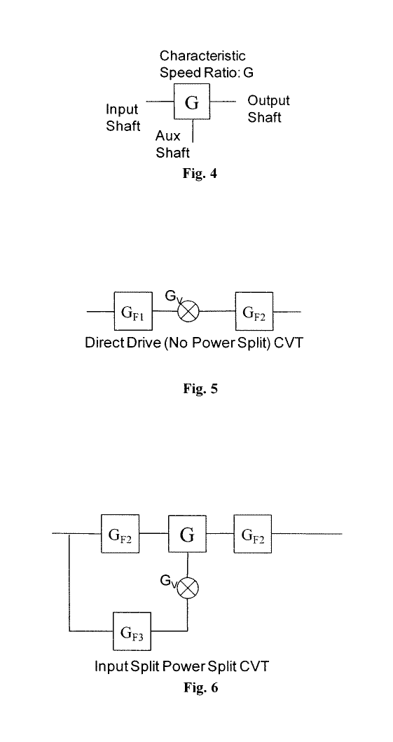

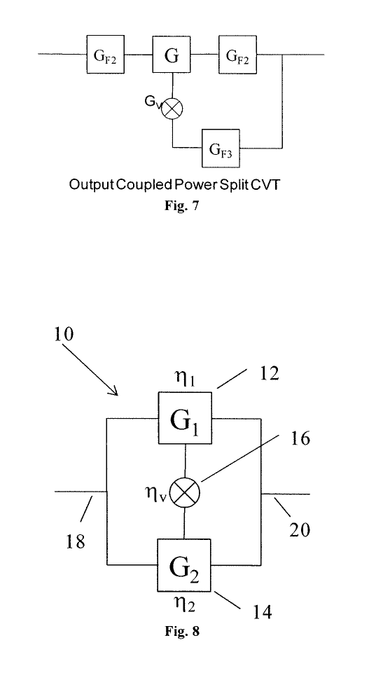

The exemplifications set out herein illustrate embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiment in different forms, the figures show, and herein described in detail, embodiments with the understanding that the present descriptions are to be considered exemplifications of the principles of the disclosure and are not intended to be exhaustive or to limit the disclosure to the details of construction and the arrangements of components set forth in the following description or illustrated in the figures.

### Construction:

As shown in FIG. 8, an arrangement of the Power Split devices and Variators can be used to arrive at a new Continuously Variable Transmission configuration for wind power applications.

Referring now to an embodiment in more detail, in FIG. 8, a Continuously Variable Transmission, CVT 10 consisting of one Power Split device 12 can be connected to a second Power Split Device 14 via a Variator 16. Each of the Input Shafts of the Power Split devices 12, 14 are connected to the input shaft 18 of the CVT 10, and each of the Output Shafts of the Power Split Devices 12,14 are connected to the output shaft 20 of the CVT 10.

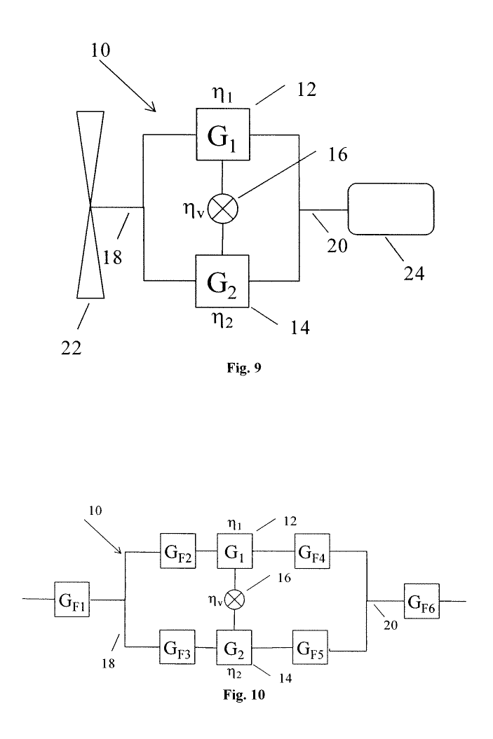

In more detail, still referring to FIG. 8, the CVT 10 when used in energy generation applications such as a wind turbine connects to a turbine 22 and a generator 24 as shown in FIG. 9. The behavior of the CVT 10 is such that the turbine 22 can operate subject to its optimal efficiency characteristics while also allowing the generator 24 to operate subject to its own optimal efficiency characteristics.

In addition to the basic arrangement shown, many additional arrangements can be utilized while maintaining the same fundamental philosophy:
(i) Use of Two Power Split devices that will essentially distribute the power from the turbine into two different paths;
(ii) This split of power is controlled by controlling the power flow through the Variator.

FIG. 10 shows a schematic of an arrangement from which other arrangements can be obtained by selectively removing Fixed Ratio Devices.

### Operation:

The control of Variator 16 determines the speed ratio across the CVT 10 between the input shaft 18 and the output shaft 20 and the power flows between the turbine 22, Power Split devices 12, 14, Variator 16, and Generator 24, and the overall system efficiency.

The operations are controlled by a computer or microprocessor 26 as shown in FIG. 11, still referring to FIG. 8. The computer 26 receives sensor signals measuring different quantities such as turbine speed 28, auxiliary shaft speed 30 of Power Split device 14, auxiliary shaft speed 32 of Power Split device 12, and Generator speed and Generator variables 34. Based on these signals, Target Speeds for the auxiliary shafts of both the Power Split devices are calculated and shown as signal 38 going from the computer to the Variator. The algorithm for the Target Speeds calculation is based on understanding the dynamic characteristics of the wind turbine and the generator, the efficiencies of the Variator, and the gear ratio and efficiency characteristics of the Power Split devices.

### Realization of the CVT:

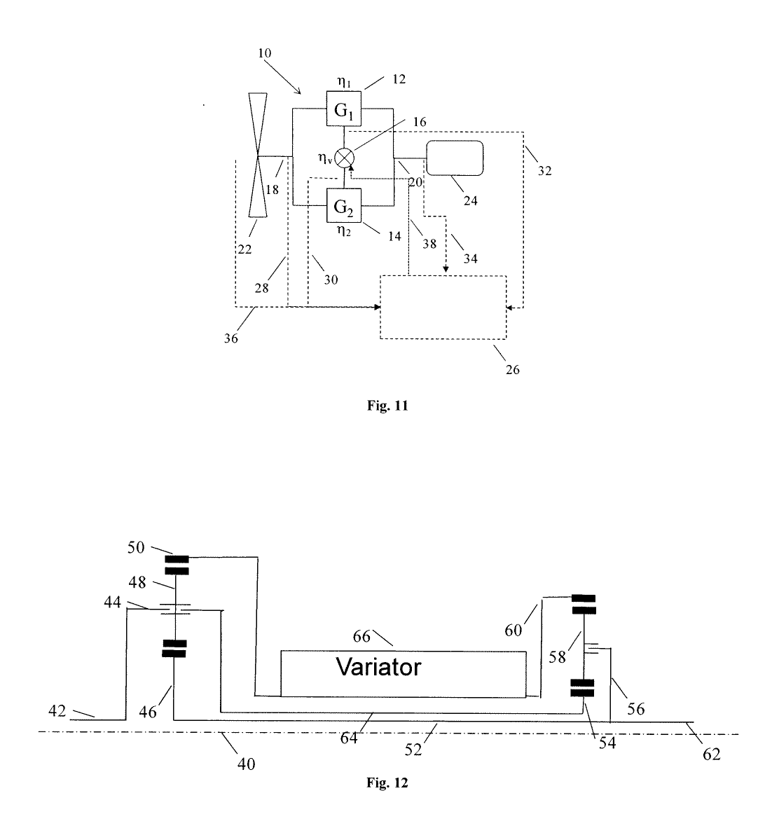

As shown in FIG. 12, two planetary gears sets serve as the two Power Split devices. The first planetary gear set consists of the sun 46, the planets 48, the ring 50, and the planetary carrier 44. The second planetary gear set consists of the sun 54, the planets 58, the ring 60, and the planetary carrier 56. The input shaft 42 (which would be connected to the wind turbine side) is connected to the planetary carrier 44. The output shaft 62 (which would be connected to the generator side) is connected to the planetary carrier 56. The sun 46 is connected to the output shaft 62 through a shaft 52 running along the axis 40. The input shaft is connected through the planetary carrier 44 and through the coaxial shaft 64 to the sun 54. The ring 50 and the ring 60 are connected coaxially through the Variator 66.

In a typical application, the input shaft 42 can be connected to the wind turbine through a fixed ratio device, which is not shown in FIG. 12.

### Realization of the Variator:

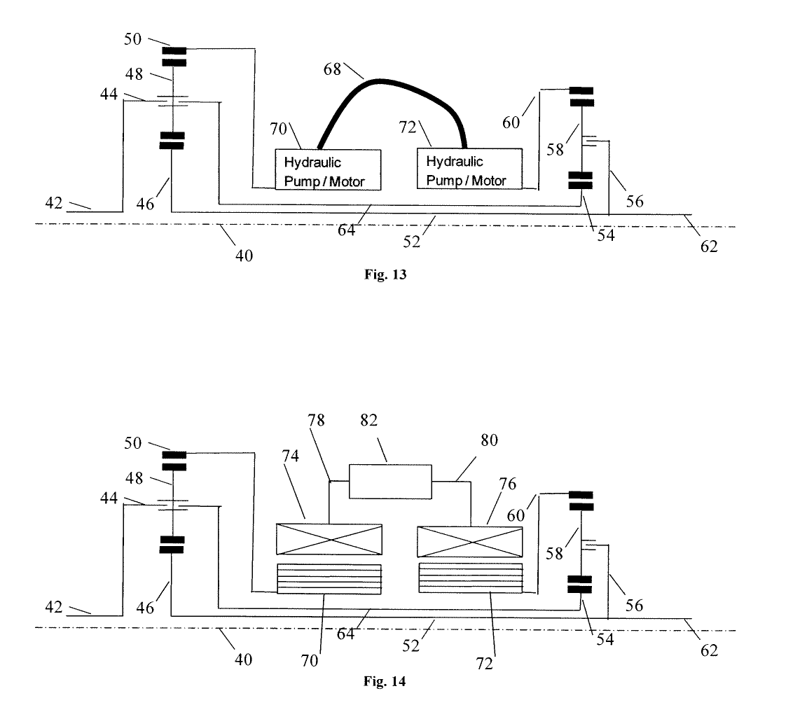

Realizations of the Variator 66 are shown in FIGS. 13 and 14. But variators may include (1) a mechanical Belt Transmission with variable sheaves, (2) a mechanical Toroidal Transmission, (3) a hydraulic or pneumatic pump/motor combination, and (4) an Electric Motor/Generator Combination.

In FIG. 13, the Variator is realized through a pair of Hydraulic Pump/Motors. Ring 50 is connected to hydraulic pump/motor 70, while ring 60 is connected to hydraulic pump/motor 72. The two hydraulic devices are connected to each other through appropriate plumbing and valves 68. Further the two hydraulic devices are capable of being controlled by a computer.

FIG. 14 shows an electrical realization of the Variator. Ring 50 is connected to a Squirrel Cage 70, and similarly ring 60 is connected to a squirrel cage 72. The two squirrel cages rotate on bearings coaxially to axle 64. Additionally, they have stator coils 74 and 76 respectively around them. These stator coils 74 and 76 are connected to each other through wires 78 and 80, and a Power Electronics Converter 82. The current through the coils 74 and 76 can be controlled from a computer. This example of a Variator is essentially a pair of electric motor/generators, along with appropriate power converters.

In addition to the mechanization shown, any other electrical Variator can be used as long as the power flow through the Variator can be controlled from a computer.

### Extension to Energy Storage

In addition to optimizing the efficiency of harnessing wind power, another challenge is routinely faced, namely wind gusts that can cause large variations in the loading seen by the generator, the gears, and the electric grid. Further, this variation also has the potential to increase the turbine speed beyond safety limits.

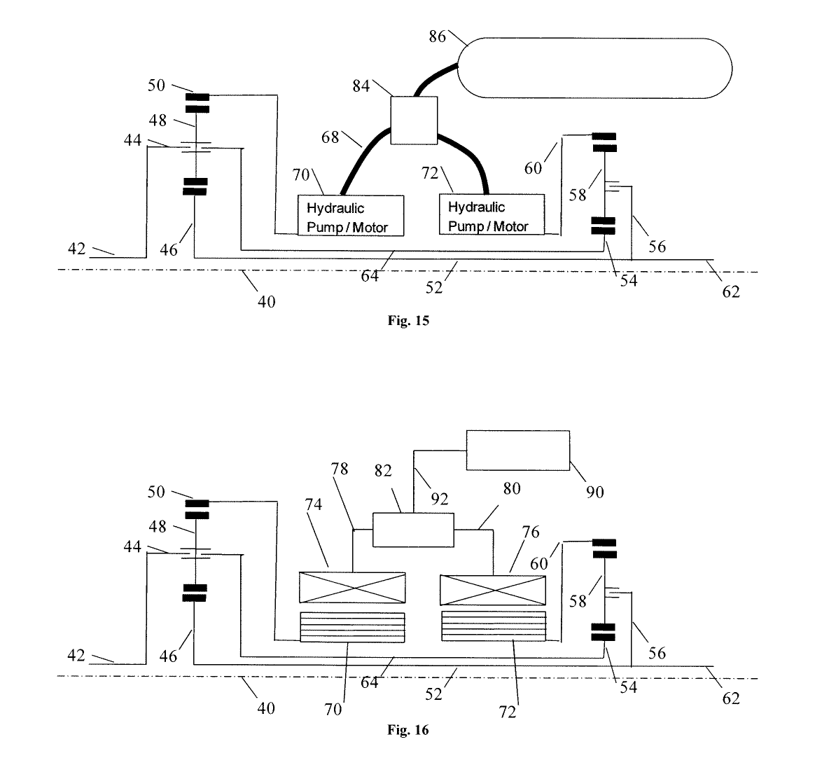

In these situations, it is useful to have the ability to funnel some of the wind power into an energy storage system. The present disclosure can be extended in a relatively straightforward way to accommodate an energy storage system also. FIG. 15 and FIG. 16 show some possible realizations of this concept.

FIG. 15 shows the hydraulic variator, and correspondingly, a hydro-pneumatic storage system is proposed, such as an accumulator for energy storage. Hydraulic Valve controls 84 takes/provides some of the power flow going through hydraulic pump/motor system based on commands from the computer.

Similarly for a system with an electro-magnetic Variator, a battery pack can be used to store excess energy. FIG. 16 shows a battery system 90 connected to the power converter through wires 92. This system provides a very convenient path to store energy without unnecessary loading on the generator.

The advantages of the present disclosure include, without limitation:
Optimizing system efficiency by maximizing power flow through the primary flow paths.
Allowing a wider speed-ratio band between the input and output devices subject to constraints on the power flow through the Variator path than other CVT devices as used in energy generation applications.
Statistically reducing loading of gear train because of sharing of power flow through the gear meshes, with potential benefits in terms of reliability.
Allowing easy extension to energy storage devices to absorb sudden power fluctuations.

There is preferably a non-linear relationship between power through the variator 16 and overall transmission ratio of the CVT 10.

In a broad embodiment, the present disclosure is a variable transmission ratio device constructed from fixed ratio devices that optimize system efficiency by maximizing power flow through the primary power flow paths and allowing a wide speed ratio band between the connected input and output devices.

While the foregoing written description of the disclosure enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the invention as claimed.

What is claimed is:

1. For energy generation applications where optimized system efficiency entails coupling input and output devices with varying speed ratios of input and output shafts for optimal component efficiency, a continuously variable transmission ratio device comprising:
a planetary power split transmission device including
a first fixed gear ratio device;
a second fixed gear ratio device; and
a variator allowing variable speed ratios connected between the first fixed gear ratio device and the second fixed gear ratio device for controlling the fixed gear ratio devices that optimize efficiency by maximizing power flow through primary power flow paths and allowing a wide range of speed ratios between coupled input and output shafts.

2. The continuously variable transmission ratio device of claim 1 wherein the output device is a generator that delivers electrical power, the output device having a generator shaft as the output shaft that has an optimal speed of rotation for generating power.

3. The continuously variable transmission ratio device of claim 2 wherein the input device is a wind turbine that delivers electrical power, the input device having an input shaft that has a varying speed of rotation wherein the speed ratio is the ratio of speed of the generator shaft to the speed of the input shaft.

4. The continuously variable transmission ratio device of claim 1 wherein the variator is a pair of hydraulic devices connected to each other by plumbing or valves.

5. The continuously variable transmission ratio device of claim 4 further comprising a hydro-pneumatic energy storage system.

6. The continuously variable transmission ratio device of claim 1 wherein the variator is electromagnetic.

7. The continuously variable transmission ratio device of claim 6 wherein the variator includes a first ring of the first fixed gear ratio device connected to a first rotatable squirrel cage and second ring of the second fixed gear ratio device connected to a second rotatable squirrel cage.

8. The continuously variable transmission ratio device of claim 7 further comprising a battery to store excess energy.

9. A mechanical power transmission device that allows for range of speed ratios between coupled input and output shafts, the power transmission device comprising a continuously variable transmission device having
a variator
a first planetary gear set having a first sun, first planets, a first ring, and a first planetary carrier, which is connected to the input shaft; and
a second planetary gear set having a second sun, second planets, a second ring, and a second planetary carrier, which is connected to the output shaft;
wherein the first sun is connected to the output shaft through a third shaft, and the first ring and second ring are connected coaxially through the variator.

10. The mechanical power transmission device of claim 9 wherein the variator is a pair of hydraulic devices connected to each other by plumbing or valves.

11. The mechanical power transmission device of claim 10 further comprising a hydro-pneumatic energy storage system.

12. The mechanical power transmission device of claim 9 wherein the variator is electromagnetic.

13. The mechanical power transmission device of claim 12 further comprising a battery to store excess energy.
